(19) United States
(12) Patent Application Publication
(10) Pub. No.: US 2015/0127715 A1
(43) Pub. Date: May 7, 2015

(54) DECOUPLED DICTIONARY AND TRANSMISSION SERVICES OVER COMMUNICATIONS NETWORKS

(71) Applicant: ViaSat Inc., Carlsbad, CA (US)

(72) Inventor: Mark D. Dankberg, Encinitas, CA (US)

(73) Assignee: ViaSat Inc., Carlsbad, CA (US)

(21) Appl. No.: 14/070,977

(22) Filed: Nov. 4, 2013

(51) Int. Cl. H04L 29/08; H04L 29/06

(52) U.S. Cl. CPC H04L 67/2857; H04L 67/42
USPC 709/203

(57) ABSTRACT

Systems and methods are described for providing dictionary services that can be decoupled from transmission services. For example, a subscriber can request content via a network of a transmission services provider, which offers dictionary services via a third-party dictionary services provider. In response to receiving the content request from the subscriber, the transmission services provider can issue a dictionary request to the dictionary services provider, which maintains subscriber dictionary models that indicate which data blocks are presently stored in each subscriber's local storage. As data blocks are received from a content source in response to the content request, a dictionary model corresponding to the requesting subscriber can be accessed and used to determine which of the data blocks are presently stored in the subscriber's local storage. The transmission services provider can use those determinations to communicate only those data blocks the requesting subscriber does not already have in local storage.

### FIELD

Embodiments relate generally to communications systems, and, more particularly, to delivery of decoupled dictionary and transmission services over communications networks.

### BACKGROUND

The ability of communications service providers to satisfy their users' demands for content is often constrained by communications infrastructure limitations. For example, different communications infrastructures manifest different amounts of latency, bandwidth, cost (e.g., subscriber cost per byte), etc. Some techniques to address these constraints can often exploit client-side storage to maintain the impression of real-time content delivery, while communicating less data in real time. However, such techniques can be of limited or no use in servicing nomadic users (e.g., users moving between networks and/or service providers), particularly in context of streaming media, media under certain restrictions (e.g., protected by digital rights management techniques, advertisement or other contractual obligations, etc.), changing served content (e.g., cloud-based content that may have changed since it was last accessed by the user), etc.

### BRIEF SUMMARY

Among other things, systems and methods are described for providing and implementing dictionary services that are decoupled from transmission services. According to an illustrative embodiment, a subscriber requests content via a network of a transmission services provider, which offers dictionary services via a third-party dictionary services provider. In response to receiving the content request from the subscriber, the transmission services provider can issue a dictionary request to the dictionary services provider, which maintains subscriber dictionary models that indicate which data blocks are presently stored in each subscriber's local storage. As data blocks are received from a content source in response to the content request, a dictionary model corresponding to the requesting subscriber can be accessed and used to determine which of the data blocks are presently stored in the subscriber's local storage. The transmission services provider can use those determinations to communicate only those data blocks the requesting subscriber does not already have in local storage.

According to one set of embodiments, a method is provided for communicating content to subscriber terminals over a communications network. The method includes: receiving, by a dictionary server of a dictionary services provider from a provider-side system of a transmission services provider, a dictionary request for one of a number of client dictionary models associated with one of a number of subscriber terminals, the dictionary request corresponding to a content request by the subscriber terminal for receipt of a content object from a content source; receiving, by the dictionary sever, fingerprints generated as a function of byte-level information of data blocks of the content object; determining, by the dictionary server in response to receiving the dictionary request, which data blocks of the content object are presently stored in a client-side dictionary of the subscriber terminal according to the fingerprints and the requested client dictionary model; and communicating, from the dictionary server to the provider-side system, which data blocks are determined to be presently stored in the client-side dictionary of the subscriber terminal.

According to another set of embodiments, a dictionary services provider system is provided for communicating content to subscriber terminals over a communications network. The system includes: a storage having a number of client dictionary models associated with subscriber dictionaries of a number of subscriber terminals; and a dictionary server, in communication with the storage. The dictionary server operates to: receive a dictionary request from a provider-side system of a transmission services provider, the dictionary request corresponding to a content request by one of the subscriber terminals for receipt of a content object from a content source; receive fingerprints generated as a function of byte-level information of data blocks of the requested content object; determine which data blocks of the content object are presently stored in a client-side dictionary of the subscriber terminal according to the fingerprints and according to one of the client dictionary models that corresponds to the requesting subscriber terminal; and communicate, to the provider-side system, which data blocks are determined to be presently stored in the client-side dictionary of the subscriber terminal.

According to another set of embodiments, another dictionary services provider system is provided for communicating content to a plurality of subscriber terminals over a communications network. The system includes: a set of processors (i.e., one or more processors); and a non-transient computer-readable storage medium, in communication with the set of processors and with a number of client dictionary models associated with subscriber dictionaries of a number of subscriber terminals. The storage medium has instructions stored thereon which, when executed, cause the set of processors to: receive a dictionary request from a provider-side system of a transmission services provider, the dictionary request corresponding to a content request by one of the subscriber terminals for receipt of a content object from a content source; receive fingerprints generated as a function of byte-level information of data blocks of the requested content object; determine which data blocks of the content object are presently stored in a client-side dictionary of the subscriber terminal according to the fingerprints and according to one of the client dictionary models that corresponds to the requesting subscriber terminal; and communicate, to the provider-side system, which data blocks are determined to be presently stored in the client-side dictionary of the subscriber terminal.

### BRIEF DESCRIPTION OF THE DRAWINGS

The present disclosure is described in conjunction with the appended figures:

FIG. 1 shows a block diagram of a communications environment, in which communications services are provided to a subscriber by both a transmission services provider and a dictionary services provider, according to various embodiments;

FIG. 2 shows a communications environment, in which dictionary services are decoupled from transmission services such that the dictionary services can be offered to a subscriber terminal over multiple transmission services provider infrastructures;

FIG. 3 shows a communications environment in which dictionary services are decoupled from some transmission services such that a transmission services entity can offer roaming dictionary services to a subscriber terminal over multiple transmission services provider infrastructures including their own;

FIG. 4 shows a computational system that operates to perform various functions of the dictionary services provider infrastructure, according to various embodiments;

FIG. 5 shows a flow diagram of a method for providing decoupled dictionary services, according to various embodiments;

FIG. 6 shows a flow diagram of a method for providing decoupled dictionary services, in which a dictionary services provider performs proxy and fingerprinting functions, according to various embodiments;

FIG. 7 shows a flow diagram of another method for providing decoupled dictionary services, in which a transmission services provider performs proxy and fingerprinting functions, according to various embodiments; and

FIG. 8 shows a flow diagram of yet another method for providing decoupled dictionary services, in which a transmission services provider and a dictionary services provider share performance of proxy and fingerprinting functions, according to various embodiments.

In the appended figures, similar components and/or features can have the same reference label. Further, various components of the same type can be distinguished by following the reference label by a second label that distinguishes among the similar components. If only the first reference label is used in the specification, the description is applicable to any one of the similar components having the same first reference label irrespective of the second reference label.

### DETAILED DESCRIPTION

The ability of communications service providers to satisfy their users' demands for content is often constrained by communications infrastructure limitations. For example, different communications infrastructures manifest different amounts of latency and bandwidth. Communications service providers can use a number of different techniques to address these constraints, such as content pre-positioning and deltacasting. Such techniques can exploit client-side storage to maintain the impression of real-time content delivery, while communicating less data in real time.

However, deltacasting-related techniques may rely on a coupling between transmission services and certain subscriber services (e.g., hosting and exploitation of subscriber dictionary services). Accordingly, use of such techniques may be of limited or no use in contexts where a particular transmission services provider is potentially not a provider of dictionary services. For example, nomadic users often move between networks of potentially different transmission service providers, of which some or all are not dictionary services providers. In these types of contexts, it can still be desirable for both services providers and consumers (e.g., subscribers to be able to exploit features of dictionary services and/or other compression techniques.

Embodiments are described for providing and implementing dictionary services that are decoupled from transmission services. According to an illustrative embodiment, a subscriber requests content via a network of a transmission services provider (e.g., using a mobile device), which offers dictionary services via a third-party dictionary services provider. In response to receiving the content request from the subscriber, the transmission services provider can issue a dictionary request to the dictionary services provider, which maintains subscriber dictionary models that indicate which data blocks are presently stored in each subscriber's local storage (e.g., subscribers' cell phone storage). A dictionary model corresponding to the requesting subscriber can be accessed and used, as data blocks are received from a content source in response to the content request, to determine which of the data blocks are presently stored in the subscriber's local storage (e.g., by fingerprinting the received data blocks and comparing the fingerprints to dictionary entries). The transmission services provider can use those determinations to communicate only those data blocks that the requesting subscriber does not already have in local storage.

Some embodiments use such decoupled deltacasting techniques to satisfy nomadic users of communications services. For example, the subscriber makes the content request from the cellular telephone while at home on a home wireless network provided by one transmission services provider. While receiving content in response to the request, the subscriber steps out of the home wireless network coverage area and into a cellular coverage area provided by a second transmission services provider. Then, still receiving content in response to the request, the subscriber steps into a wireless coverage area of an airport terminal provided by a third transmission services provider. The dictionary services can be decoupled from any or all of the transmission services providers in such a way that access to the subscriber's dictionary model can effectively be shared by some or all of the transmission services providers. In this way, deltacasting techniques can be used to satisfy the subscriber's content request even as the subscriber moves between networks of different transmission services providers.

In the following description, numerous specific details are set forth to provide a thorough understanding of various embodiments. However, one having ordinary skill in the art should recognize that the invention can be practiced without these specific details. In some instances, circuits, structures, and techniques have not been shown in detail to avoid obscuring the present invention. Terms such as “optimize” or “maximize” are intended to connote a relative or desired outcome, rather than an absolute outcome, and should not be considered as limiting potential embodiments. For example, embodiments described with reference to optimization are intended to include even variations deemed to be sub-optimal.

As used herein, terms and phrases, like “dictionary services” and “dictionary techniques” (and similarly “deltacasting,” “delta coding,” “dictionary coding,” “dictionary,” and the like), are intended to broadly include use of any type of dictionary-like structure for communications resource optimization. For example, some implementations exploit subscriber dictionary models to identify opportunities for multicasting, pre-positioning, and/or avoiding redundant communications to improve utilization of communications links. Some examples of techniques employing certain dictionary services, including “deltacasting” techniques and related functionality, are described in U.S. patent application Ser. No. 12/651,909, titled “DELTACASTING,” which is hereby incorporated by reference in its entirety. As described herein, use of dictionary techniques in nomadic or otherwise potentially decoupled contexts, can improve network resource usage and subscriber experience even where some other techniques can have limited effect, for example, with certain streaming content (e.g., streaming media), changing content (e.g., where hosted content may have changed since it was last accessed), restricted content (e.g., content protected by or governed under digital rights management, contractual obligations, etc.), etc. Some such functionality involves receiving data in certain ways. As used herein, terms like “intercepting,” “receiving”, and the like, in context of content communications, are generally intended to broadly include any suitable slowing, sampling, re-routing, and/or other techniques that allow processing of the data as involved with various embodiments. For example, traffic can pass through provider-side components, where it can be “intercepted” by being buffered, thereby slowing and accumulating the traffic for analysis and processing (e.g., for fingerprint generation and analysis).

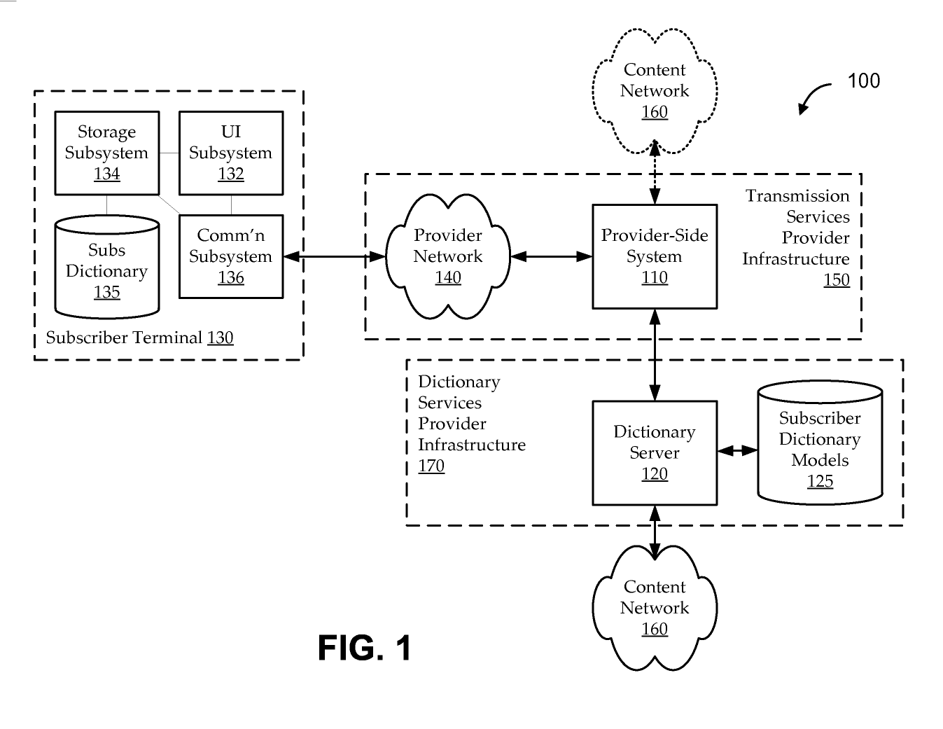

Turning first to FIG. 1, a block diagram is shown of a communications environment 100 in which communications services are provided to a subscriber by both a transmission services provider and a dictionary services provider, according to various embodiments. As illustrated, subscriber terminals 130 are in communication with a transmission services provider infrastructure 150 via a provider network 140. Embodiments of the subscriber terminals 130 can include any suitable components for providing subscribers with network interactivity and other functionality described herein. For example, the subscriber terminals 130 can include any type of computational device, network interface device, communications device, or other device for communicating data to and from the subscriber. In some embodiments, the subscriber terminal 130 is implemented in a mobile terminal, such as a smart phone, laptop computer, tablet computer, etc. Regardless of whether the subscriber terminal 130 is implemented in a fixed or mobile terminal, embodiments of the subscriber terminals 130 generally include user interface functionality, local storage functionality, and communications functionality (illustrated as a user interface subsystem 132, a storage subsystem 134, and a communications subsystem 136). The user interface functionality of the subscriber terminals 130 can permit the subscriber to issue content requests, access locally stored content, and/or perform any other suitable interface functions. For example, the user interface functionality can include display and handling of graphical user interfaces (GUIs), provision and handling of interface devices (e.g., touch screens, keyboards, displays, etc.), etc.

The storage functionality of the subscriber terminals 130 can facilitate local storage of any suitable types of data, including subscriber dictionaries 135 that include content received over the provider network and/or from other sources (e.g., the storage subsystem 134 is illustrated in communication with the subscriber dictionary 135 of the subscriber terminal 130). The local storage can include any suitable non-transient, integrated and/or removable storage device or devices, such as disk drives, random access memories (RAMs), secure digital (SD) cards, thumb drives, etc. The subscriber dictionaries 135 can be implemented in any manner suitable for facilitating dictionary functionality. In some embodiments, the subscriber dictionaries 135 include chunks of content data. (e.g., implemented as delta dictionaries, wide dictionaries, byte caches, and/or other types of dictionary structures). For example, when content data is stored in the subscriber dictionaries 135, some or all of the blocks of data. defining the content are stored in the dictionary in an unordered, but indexed way. As such, content may not be directly accessible from the dictionary; rather, the set of indexes may be needed to recreate the content from the set of unordered blocks. Some implementations of the subscriber dictionaries 135 can generate and/or include fingerprints of data chunks stored in the dictionary. As used herein, the term “fingerprints” is intended to generally include any content chunk identifier of sufficient “strength” to be used for dictionary services implementations. For example, fingerprints can include message digests, signatures, cryptographic or other hash functions, and/or any other suitable bit sequence calculated from the content portion of data packets traversing the communication links. In some instances, a so-called “weak” identifier can be used, so long as it is sufficiently strong to identify candidate matches with blocks stored in a dictionary.

The communications functionality of the subscriber terminals 130 can facilitate communications between the subscriber terminals 130 and the transmission services provider infrastructure 150, including communication of content requests and receipt of content. The communications functionality can include any suitable types of wired and/or wireless communications components, such as antennas, protocols, encoders, decoders, amplifiers, ports, etc. The subscriber terminals 130 can communicate via one or more provider networks 140 to access services from the transmission services provider infrastructure 150.

Embodiments of the provider network 140 can include any number of networks and/or types of communications links, including, for example, Internet, Internet protocol (“IP”), intranet, wide-area network (“WAN”), local-area network (“LAN”), virtual private network (“VPN”), Public Switched Telephone Network (“PSTN”), and/or any other suitable types of wired and/or wireless communications links. Provider-side functionality (i.e., services provided via. the transmission services provider infrastructure 150), including certain functionality described herein, can be performed by components of a provider-side system 110. For example, depending on the types of networks involved in the transmission services provider infrastructure 150, provider-side system 110 can include satellite base stations or gateways, cable head-ends, digital subscriber line access multiplexers (DSLAMs), core network components, and/or any other suitable components. In some implementations, the provider-side system 110 implements server-side optimizer functions for interacting with client-side optimizer functions. For example, the optimizer functions can involve a proxy client-server implementation (e.g., over a proxy tunnel), in-line optimizers, cloud-based optimizers, etc.

As illustrated, the transmission services provider infrastructure 150 is in communication with a dictionary services provider infrastructure 170, for example, via the provider-side system 110. The dictionary services provider infrastructure 170 can include a dictionary server 120 and subscriber dictionary models 125. The subscriber dictionary models 125 can be implemented in any manner suitable for facilitating dictionary functionality in conjunction with the subscriber dictionaries 135 of the subscriber terminals 130. For example, each subscriber dictionary model 125 is a model of the subscriber dictionary 135 corresponding to a particular subscriber terminal 130. In various implementations, the subscriber dictionary models 125 can include chunks of content data and/or fingerprints corresponding to chunks of content data. Various synchronization and/or validation techniques can be used to help ensure that the subscriber dictionary models 125 accurately represent a present state of each corresponding subscriber dictionary 135. For example, in some implementations, messages are communicated from subscriber terminals 130 to the dictionary server 120 to inform the dictionary server 120 of data blocks that have been added to the corresponding subscriber dictionary 135 (e.g., from sources other than the transmission services or dictionary services providers, as an acknowledgement of receipt, etc.), data blocks that have been removed from the corresponding subscriber dictionary 135 (e.g., content that has been explicitly deleted by a. user, automatically removed after becoming stale or becoming sufficiently low in priority, automatically removed to make room for other content, etc.), and/or data blocks that have otherwise changed state (e.g., become stale, changed priority, become corrupted or unreadable, etc.). The messages can be communicated periodically, as desired, as requested by the dictionary server 120, and/or in any other suitable fashion.

For the sake of illustration, a subscriber terminal 130 requests content over the transmission services provider infrastructure 150 to the provider-side system 110. The requested content can be streaming media, content stored in the cloud, or any other suitable content, and the content request can be issued through a web browser, an application, or in any other suitable manner. The content request can be explicit (e.g., initiated directly by a subscriber) or implicit (e.g., initiated on behalf of the subscriber by the provider-side system 110 and/or the dictionary server 120, for example, as anticipatory pre-positioning; as part of a subscription to a channel, feed, or other dynamic content source; as prefetched content; etc.). When the content request is received by the provider-side system 110, a determination can be made that dictionary services can and should be used to handle the request. In some implementations, all content requests are handled using dictionary coding techniques wherever practical. In other implementations, content requests are handled using dictionary coding techniques only when the subscriber terminal 130 corresponds to a subscriber of dictionary services (e.g., the subscriber's transmission services plan includes dictionary services, the subscriber's media plan includes dictionary services, etc.).

As discussed below, various embodiments permit the dictionary services provider infrastructure 170 to be “decoupled” from the transmission services provider infrastructure 150, so that they can be operated by separate entities. According to some such decoupled services offerings, one or more transmission services providers can provide dictionary services to subscriber terminals 130 via a third-party dictionary services provider. According to other such decoupled services offerings, multiple transmission services providers can share dictionary services provided by one or more of those same transmission services providers (i.e., at least one of the multiple transmission services providers is also acting as a dictionary services provider). When a request transaction occurs between a subscriber terminal 130 and a particular provider-side system 110, the provider-side system 110 is acting as the transmission services provider. In some instances, the provider-side system 110 can also provide its own dictionary services (e.g., where the particular provider-side system 110 operates to provide dictionary services via. its own transmission infrastructure and through third-party transmission infrastructures). In other instances, the provider-side system 110 can only provide dictionary services through one or more third-party dictionary services providers (e.g., where the requesting subscriber terminal 130 is a subscriber to third-party transmission and/or dictionary services). In still other instances, the provider-side system 110 can provide its own dictionary services to its own subscribers, and can provide dictionary services to non-subscribers (e.g., nomadic users of its transmission infrastructure) through one or more third-party dictionary services providers. Accordingly, the provider-side system 110 can issue a dictionary request to the dictionary services provider infrastructure 170 to provide dictionary services in response to the content request. The dictionary request can correspond to the content request so that it involves particular requested data blocks and a particular subscriber dictionary model 125 associated with the requesting subscriber terminal 120.

In response to the content request, either the dictionary server 120 or the provider-side system 110 can request the content from an appropriate content source via one or more content networks 160 (e.g., the Internet, a content distribution network (CDN), etc.). In some implementations, the provider-side system 110 forwards or otherwise directs the content request to the dictionary server 120, which can then communicate with the content source. For example, the dictionary server 120 becomes a transparent intercept proxy server on behalf of the subscriber terminal 130 (as the proxy client); the dictionary server 120 issues the request to the content source on behalf of the requesting subscriber terminal 130, and intercepts data blocks received in response to the request. In other implementations, the provider-side system 110 communicates with the content source (e.g., as a transparent intercept proxy server), including issuing the request to the content source on behalf of the requesting subscriber terminal 130 and intercepting data blocks received in response to the request. Other implementations are possible, for example, using other types of redirection, proxying, and/or other techniques. When data blocks of the requested content are received, fingerprints can be generated from those blocks. For example, the dictionary server 120 can intercept and fingerprint the data blocks; the provider-side system 110 can intercept and fingerprint the data blocks, and send the fingerprints to the dictionary server 120; the provider-side system 110 can intercept the data blocks and forward the data blocks to the dictionary server 120, which can fingerprint the received data blocks; etc. The fingerprints can be calculated from each data block, from deterministic chunking of the received data, etc. For example, each data block is a packet that includes header and content information, content information from multiple blocks can be stripped (e.g., parsed) until a byte sequence of a particular length is obtained, and a cryptographic hash function can be applied to the byte sequence to generate each fingerprint.

In some embodiments, the dictionary server 120 determines which data blocks are presently stored in the requesting subscriber's dictionary 135 according to the fingerprints and the subscriber dictionary model 125. For example, the fingerprints are compared to fingerprints in the subscriber dictionary model 125, and matches indicate that the corresponding content block is presently in the subscriber terminal's 130 local storage. Having made these determinations, the dictionary server 120 can indicate to the provider-side system 110 which data blocks are apparently presently stored in the subscriber dictionary 135 of the subscriber terminal 130. In some implementations, the dictionary server 120 can communicate a list of blocks that are presently stored or are not presently stored local to the requesting subscriber terminal 130. In other implementations, the dictionary server 120 indicates to the provider-side system 110, for each intercepted content block, whether the content block is presently stored local to the requesting subscriber terminal 130. In still other implementations, the dictionary server 120 communicates to the provider-side system 110 non-compressed versions of the data blocks that are not presently stored local to the requesting subscriber terminal 130 and compressed versions (e.g., the fingerprints and/or other compressed version) of the data blocks that are not presently stored local to the requesting subscriber terminal 130. The provider-side system 110 can use this information to communicate portions of the request content data to the subscriber terminal 130 that are not presently stored in its subscriber dictionary 135. For example, the provider-side system 110 can send (e.g., multicast) only those data blocks that are not presently stored in the subscriber dictionary 135 and can send (e.g., unicast or multicast) highly compressed versions of the data blocks that are presently stored in the subscriber dictionary 135. The subscriber dictionary 135 can then use the received compressed versions to retrieve corresponding local versions of the data blocks and to construct the requested content (e.g., from local data blocks and received data blocks).

As noted above, the dictionary services provider infrastructure 170 can be “decoupled” from the transmission services provider infrastructure 150, so that they can be operated by separate entities. For example, a transmission services entity operates the transmission services provider infrastructure 150, and a separate dictionary services entity (e.g., another transmission services entity or any other suitable service provider) operates the dictionary services provider infrastructure 170. This can facilitate implementation of decoupled dictionary services, for example, as described herein. In some implementations, the transmission services entity can contract with the dictionary services entity to provide dictionary services to support decoupled dictionary services for customers of the transmission services entity. In other implementations, subscribers can subscribe to dictionary services from the dictionary services entity, which can be accessed over any transmission services provider infrastructure 150 of a particular set of participating transmission services entities.

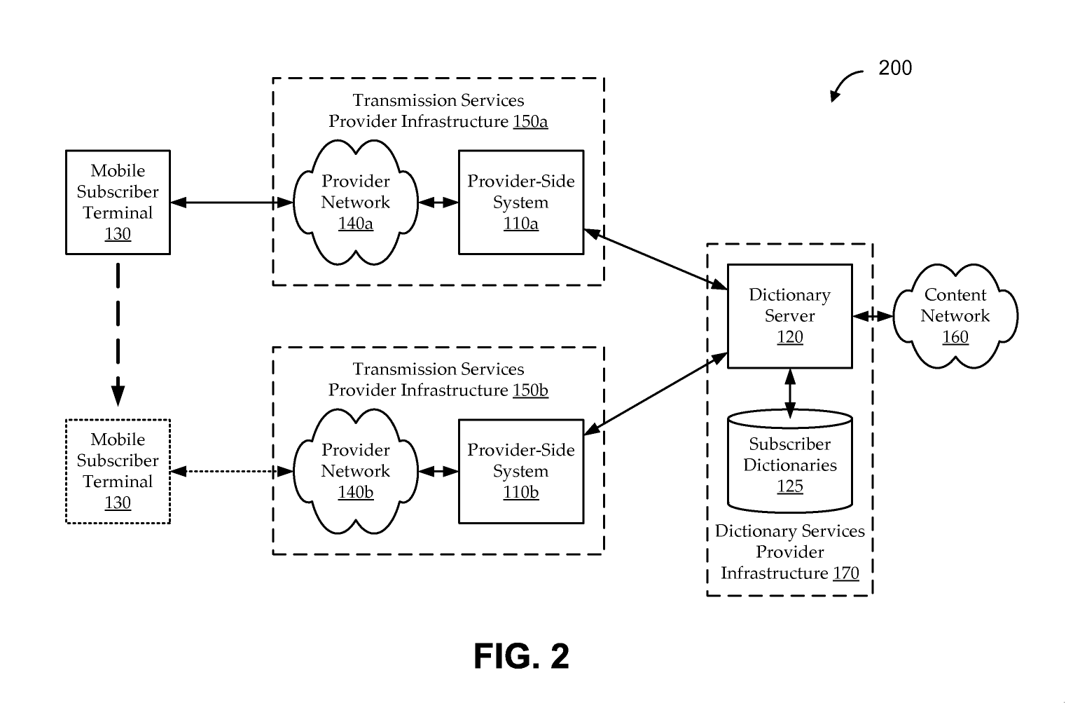

In still other implementations, subscribers can subscribe to dictionary services from the dictionary services entity, which can be accessed (e.g., as a remote service using a client application on the subscriber terminal 130, or the like) over any transmission services provider infrastructure 150. For the sake of illustration, FIG. 2 shows a communications environment 200 in which dictionary services are decoupled from transmission services such that the dictionary services can be offered to a subscriber terminal 130 over multiple transmission services provider infrastructures 150. At a first time, a subscriber uses a mobile subscriber terminal 130 to access communications services, including dictionary services of a dictionary services entity via a first transmission services provider infrastructure 150a. The first transmission services provider infrastructure 150a is in communication with (though decoupled from) the dictionary services provider infrastructure 170. At a second time, the subscriber moves to a second transmission services provider infrastructure 150b. For example, the mobile subscriber terminal 130 leaves one coverage area and enters another, the subscriber switches from a cellular to a WiFi. connection, etc. The second transmission services provider infrastructure 150b is also in communication with (though decoupled from) the same dictionary services provider infrastructure 170. The subscriber can continue to receive dictionary-related services, as the subscriber dictionary models 125 can effectively be shared by the different transmission services provider infrastructure 150 via respective communications with the same dictionary services provider infrastructure 170.

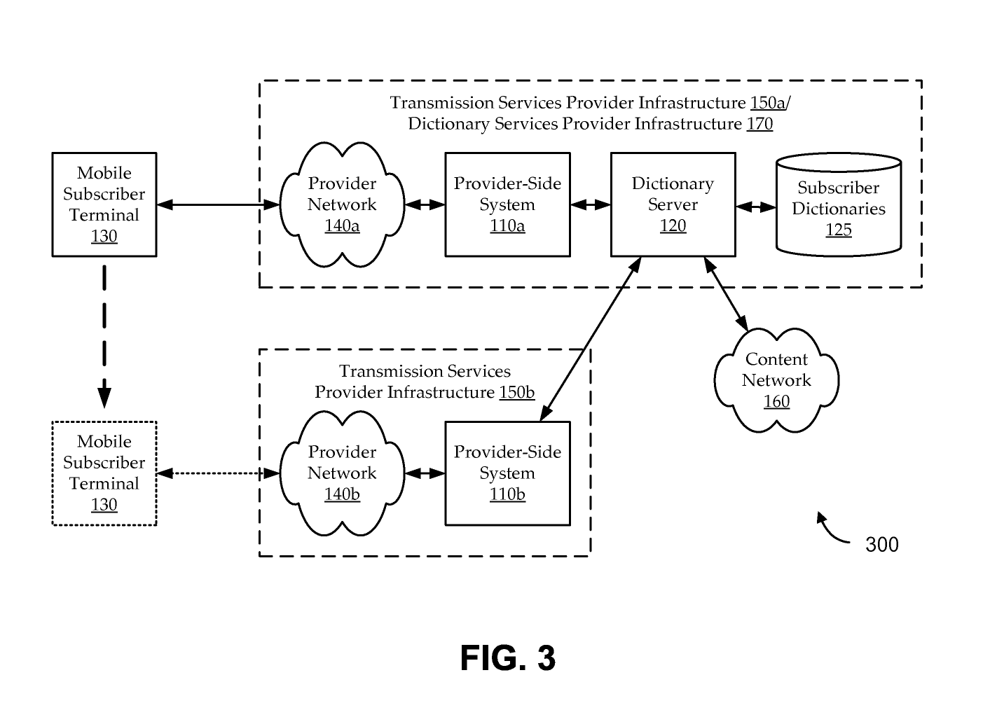

In even other implementations, a transmission services entity can also act as a dictionary services entity, and can offer a “roaming” dictionary service by which dictionary services follow the subscriber from that entity's network to other entities' networks. For the sake of illustration, FIG. 3 shows a communications environment 300 in which dictionary services are decoupled from some transmission services such that a transmission services entity can offer roaming dictionary services to a subscriber terminal 130 over multiple transmission services provider infrastructures 150 including their own. At a first time, a subscriber uses a mobile subscriber terminal 130 to access communications services, including dictionary services of a dictionary services entity via a first transmission services provider infrastructure 150a. The first transmission services provider infrastructure 150a is operated by a transmission services entity that also acts as a dictionary services entity. Accordingly, the first transmission services provider infrastructure 150a also includes elements of the dictionary services provider infrastructure 170. For example, though shown as separate components for the sake of clarity, the dictionary server 120 can be a component of the provider-side system 110 or implemented in any other suitable manner. At a second time, the subscriber moves to a second transmission services provider infrastructure 150b, which is also in communication with (though decoupled from) the same dictionary services provider infrastructure 170. In this way, the transmission services entity can continue to offer dictionary services to its subscribers even when those subscribers are using other entities' communications infrastructures. In some embodiments, the second time of FIG. 3 is effectively implemented in the same manner as the second time of FIG. 2.

Providing decoupled dictionary services can yield a number of features. One such feature is that subscribers can access and exploit their dictionaries and related services from multiple transmission services providers. Another such feature is that transmission services providers can offer dictionary services to their subscribers by using a third-party dictionary services infrastructure (e.g., without having to maintain and serve subscriber dictionaries, etc.). A similar feature is that transmission services providers can offer dictionary services to non-subscribers, such as nomadic users and/or other users of their infrastructure for whom the transmission services providers do not have dictionaries.

Another category of features stemming from expanding provision of dictionary services relates to use of subscriber dictionaries for compression in contexts where “downloading” (e.g., storing some or all of an object in accessible form) is not permitted or otherwise not desired. As one example, some media content (e.g., some streaming media) is protected by digital rights management, timestamps, or the like, and caching of the content is not permitted by the content distributors. The subscriber dictionary can be configured so that protected content objects cannot be recreated from the blocks themselves. When the content is requested by the subscriber terminal (even if the majority of the content blocks were previously stored in the subscriber dictionary), the content can be re-streamed or otherwise re-transmitted to the subscriber terminal in a. manner that exploits the subscriber dictionary for compression purposes (e.g., previously stored blocks can be sent in highly compressed form), while maintaining the protections desired by the content provider. As another example, some media content changes due to dynamic content insertion (e.g., insertion of targeted or time-based advertisements, scrolling news headlines or stock tickers, etc.) or due to updates (e.g., changes made back at the office to a media presentation being used by an employee on travel). When the content is requested by the subscriber terminal (assuming all the non-updated content blocks were previously stored in the subscriber dictionary), updated content blocks can be transmitted in a non-compressed form and previously stored (i.e., unchanged) content blocks can be sent in highly compressed form. As yet another example, a watermark or other artifact (e.g., a unique byte sequence, or an artifact that varies based on the time of the request, a random number, a hash of various subscriber-related values, etc.) can be inserted into the requested content by the transmission services provider and/or by the content provider, for example, as another form of content protection or for monitoring or tracking purposes. Again, for any of the requested content blocks that are previously stored local to the subscriber terminal and unaffected by the artifact, embodiments of the dictionary services can exploit the subscriber dictionary to send those blocks in highly compressed form while preserving the efficacy of the artifact.

Yet another category of features stemming from decoupling dictionary services from transmission services involves cost and related implications. As one illustrative scenario, suppose a subscriber requests streaming of a movie on a mobile device while the device is connected to the Internet via a high-speed home wireless network. While watching the movie, the subscriber moves the mobile device outside of the home wireless network coverage area and into a cellular coverage area (which, for the sake of the example, has an appreciably higher bandwidth cost to the cellular services provider and/or to the subscriber). Assuming that a number of content blocks of the movie were prepositioned in the subscriber's mobile device storage (e.g., either while streaming the movie via the home network or previously), the subscriber can continue to stream the movie via the cellular network with appreciable compression and a potentially lower transmission cost to the cellular network.

As another illustrative scenario, suppose a subscriber of media services goes on a flight operated by Media Airlines. Prior to going on the flight (e.g., when the subscriber was in his home transmission provider network), one or more movies were locally stored to the subscriber's mobile device (e.g., in a manner that is inaccessible without restreaming the movie, as described above). For example, the subscriber explicitly requested the movies and opted for delayed delivery, the content was anticipatorily prepositioned to the subscriber's local storage, etc. On the flight, the subscriber can “stream” the movies in a manner that appears to the subscriber and to the content source) as real-time streaming, while most of the movie is actually being sent in a highly compressed form using dictionary coding (e.g., as dictionary entries, fingerprints, etc.). For example, the Media Airlines network provider is the transmission services provider, and the media services provider is the dictionary services provider (e.g., and the transmission services provider and dictionary services providers can be the same or different entities). Without this feature, it may be impossible (e.g., not permitted by Media Airlines) or prohibitively expensive to stream the movies on the flight. In one implementation, the subscriber can access the dictionary services on the flight by accessing a website, app, or other portal to the media services provider. In another implementation, the subscriber can access the dictionary services on the flight by accessing a website, app, or other portal to Media Airlines services (e.g., services specific to the airline, the transmission services provider, etc.). :In such an implementation, the set of movies pre-stored on the mobile device can be determined at least in part by a library of movies made available to Media Airlines passengers (or loyalty program members), or the set of movies can be pre-stored on local storage of the airplane and accessible with dictionary coding services via the subscriber's mobile device. In yet another implementation, the subscriber accesses the content through a content provider portal that is configured to exploit the dictionary services (e.g., transparently to the subscriber).

The various systems described above can be implemented in various ways. For example, the functions of the transmission services provider infrastructure 150, the dictionary services provider infrastructure 170, and the subscriber-side system 110 can be implemented in hardware and or software, each in a single device, or with functions spread among multiple devices, components, systems, etc. Some implementations can include one or more Application Specific Integrated Circuits (ASICs) adapted to perform a subset of the applicable functions in hardware. Other implementations can have functions performed by one or more other processing units (or cores), on one or more integrated circuits (ICs). other embodiments, other types of integrated circuits can be used (e.g., Structured/Platform ASICs, Field Programmable Gate Arrays (FPGAs), and other Semi-Custom ICs), which can be programmed. Each can also be implemented, in whole or in part, with instructions embodied in a computer-readable medium, formatted to be executed by one or more general or application specific controllers.

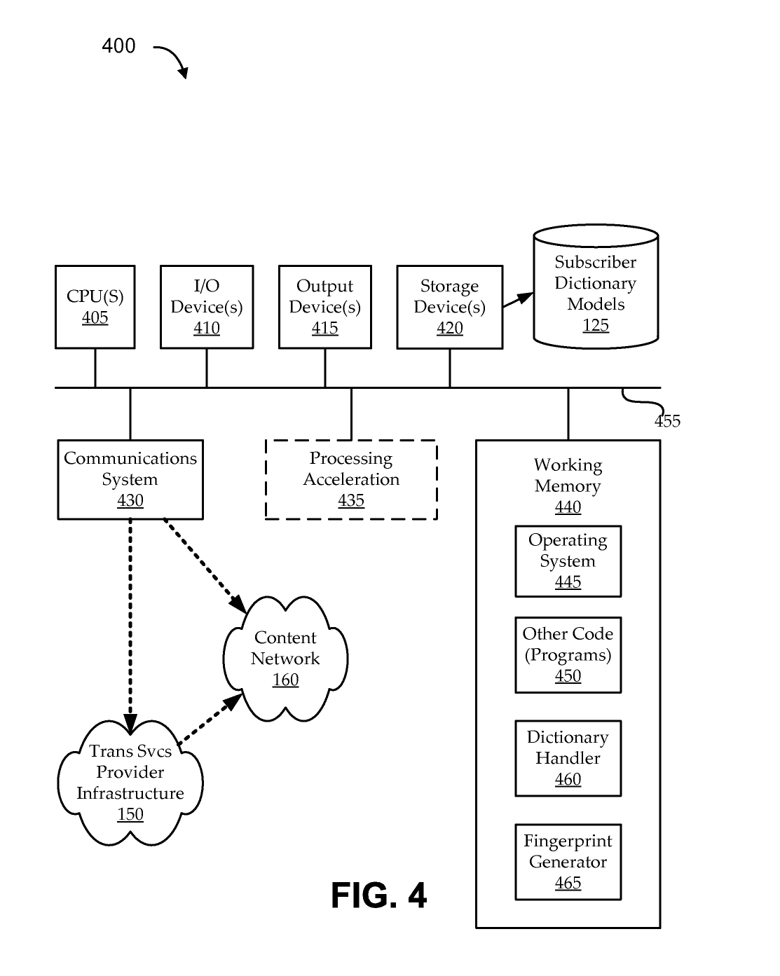

FIG. 4 shows a computational system 400 that operates to perform various functions of the dictionary services provider infrastructure 170, according to various embodiments. The computational system 400 can include or perform functionality of components of dictionary server 120 embodiments, such as those described above with reference to FIG. 1. For the sake of simplicity, the computational system 400 is shown including hardware elements that can be electrically coupled via a bus 455. However, embodiments of the computational system 400 can be implemented as or embodied in single or distributed computer systems, in one or more locations, or in any other useful way.

The hardware elements can include one or more central processing units (CPUs) 405. Some implementations include one or more input/output devices 410, such as a mouse, a keyboard, a display device, etc. The computational system 400 can also include one or more storage devices 420. By way of example, storage device(s) 420 can be disk drives, optical storage devices, solid-state storage device such as a random access memory (RAM) and/or a read-only memory (ROM), which can be programmable, flash-updateable and/or the like. In some embodiments, the storage devices 420 can include or can be in communication with the subscriber dictionary models 125, as described above. Some implementations of the storage device(s) can include one or more computer-readable storage media readers, computer-readable storage media, and/or other storage functionality that can provide remote, local, fixed, and/or removable storage devices plus storage media for temporarily and/or more permanently containing computer-readable information.

The computational system 400 can include a communications system 430 that operates to exchange data with one or more networks and/or other computational systems. For example, as described with reference to FIG. 1, content traffic, fingerprints, and/or other information can be communicated via the communications system 430 to the transmission services provider infrastructure 150, one or more content networks 160, etc. The communications system 430 can include any suitable components for performing its functions, such as antennas, ports, amplifiers, filters, encoders, decoders, etc.

Embodiments of the computational system 400 can further include working memory 440, which can include RAM, ROM, and/or other suitable memory devices. In some embodiments, the computational system 400 can also include a processing acceleration unit 435, which can include a DSP, a special-purpose processor and/or the like. The computational system 400 can also include software elements, shown as being currently located within a working memory 440, including an operating system 445 and/or other code 450, such as an application program (which can be a client application, web browser, mid-tier application, etc.). As illustrated, certain embodiments can include a dictionary handler 460 and/or a fingerprint generator 465. Implementations of the dictionary handler 460 perform some or all of the functions described above with reference to the dictionary server 120. For example, the dictionary handler 460 can receive and process dictionary requests, use the subscriber dictionary models 125 and fingerprints to determine whether data blocks are presently stored in a subscriber's dictionary 135, etc. Implementations of the fingerprint generator 465 can calculate fingerprints from data blocks. For example, the fingerprint generator 465 can calculate a cryptographic hash of a byte sequence generated from content portions of one or more data blocks. Similar types of computational systems can be used according to various embodiments to implement functions of the transmission services provider infrastructure 150 and/or the subscriber terminal 130.

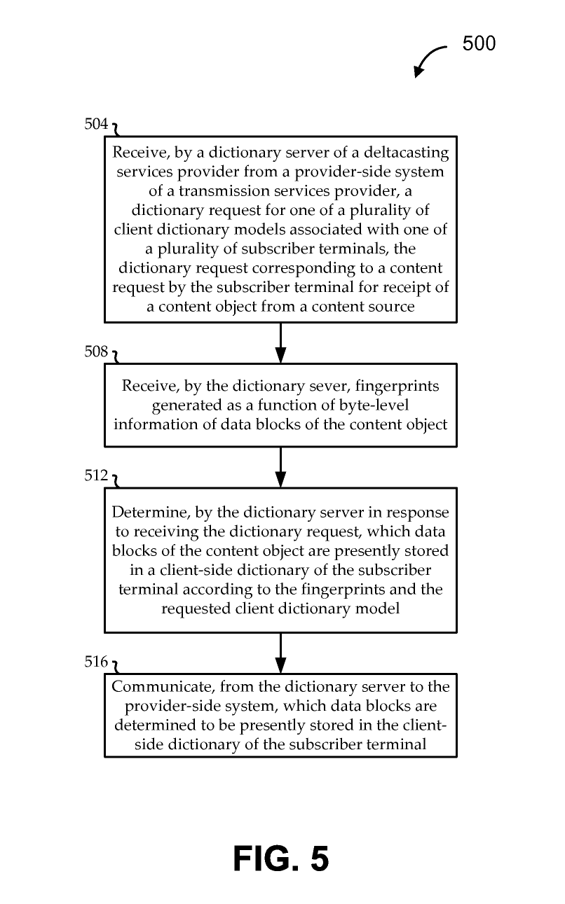

The systems described above in FIGS. 1-4 and/or other systems can be used to perform various methods, including, for example, those described in FIGS. 5-8. Turning to FIG. 5, a flow diagram is shown of a method 500 for providing decoupled dictionary services, according to various embodiments. Embodiments of the method 500 begin at stage 504 by receiving a dictionary request. The dictionary request can be received by a dictionary server of a dictionary services provider from a provider-side system of a transmission services provider. The dictionary request can correspond to a content request by a subscriber terminal for receipt of a content object from a content source, and, accordingly, can indicate a particular one of a number of client dictionary models that is associated with the requesting subscriber terminal.

At stage 508, the dictionary sever can receive fingerprints generated as a function of byte-level information of data blocks of the content object. For example, the fingerprints can be generated by the dictionary server or generated by another component (e.g., the provider-side system) and communicated to the dictionary server. At stage 512, the dictionary server can determine, in response to receiving the dictionary request, which data blocks of the content object are presently stored in a client-side dictionary of the subscriber terminal according to the fingerprints and the requested client dictionary model. For example, as data blocks of the requested content are received from the content source, those data blocks are fingerprinted. The fingerprints can be compared to a subscriber dictionary model that models which data blocks are presently stored in a corresponding subscriber dictionary.

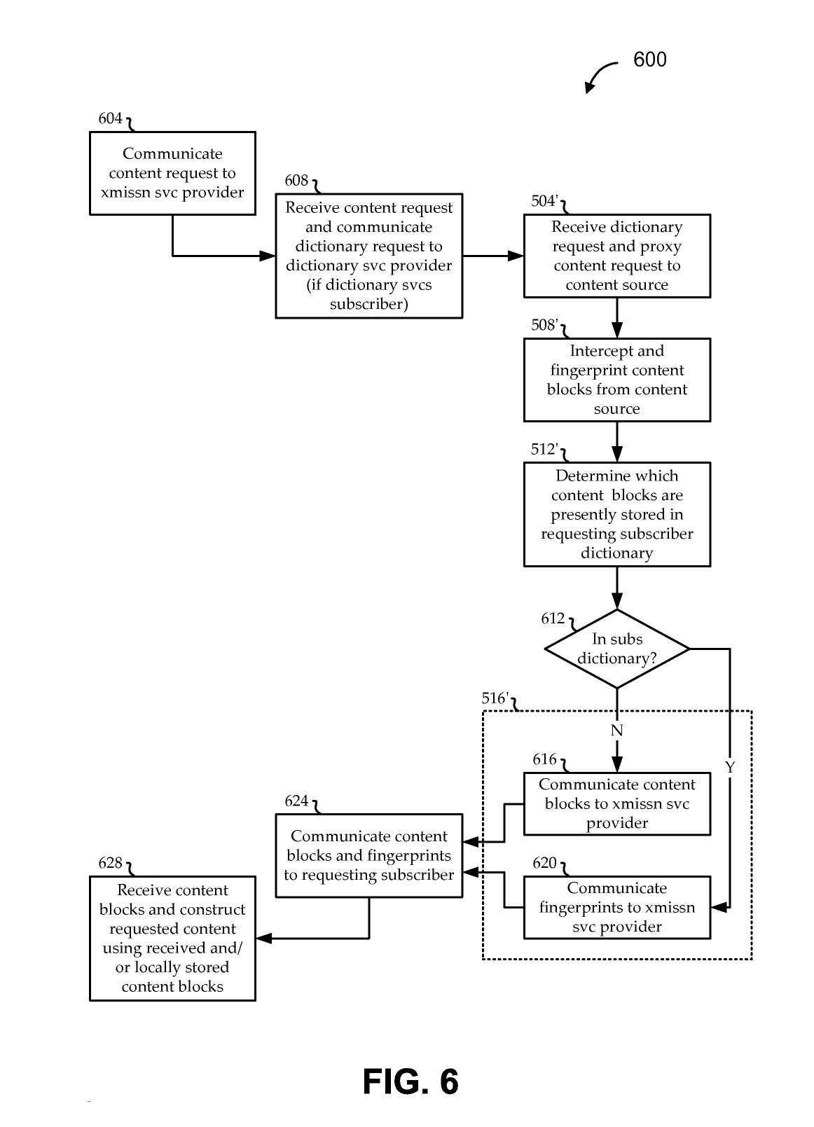

At stage 516, the dictionary server can communicate, to the provider-side system, which data blocks are determined to be presently stored in the client-side dictionary of the subscriber terminal. For example, the dictionary server can communicate an indication (e.g., a list, etc.) of which blocks are and/or are not presently stored locally to the requesting subscriber terminal, the dictionary server can communicate the actual data blocks determined not to be presently stored locally to the requesting subscriber terminal, etc. Additional context and features are illustrated in FIGS. 6-8.

FIG. 6 shows a flow diagram of a method 600 for providing decoupled dictionary services, in which a dictionary services provider performs proxy and fingerprinting functions, according to various embodiments. Embodiments of the method 600 begin at stage 604 by communicating a request from a subscriber terminal to a transmission services provider. At stage 608, the transmission services provider can receive the content request and communicate a corresponding dictionary request to a dictionary services provider. In one implementation, the transmission services provider requests dictionary services for all content requests. In another implementation, the transmission services provider requests dictionary services only after determining that the content request is from a subscriber terminal associated with a subscriber to dictionary services. In yet another implementation, the transmission services provider always performs dictionary services when possible in response to content requests; however, based, for example, on a determination of the subscriber's subscriptions, the transmission services provider can perform the dictionary services itself or requests the dictionary services from a third-party dictionary services provider. Other implementations are possible according to other embodiments.

At stage 504′, embodiments of the method 600 continue by receiving the dictionary request by the dictionary services provider. As described above with reference to FIG. 5, the dictionary request can correspond to the content request and can, accordingly, invoke a particular client dictionary model associated with the requesting subscriber terminal. As illustrated, in response to receiving the dictionary request, the dictionary services provider can communicate the content request to an appropriate content source on behalf of the requesting subscriber terminal (e.g., as a proxy). At stage 508′, the dictionary services provider can receive (e.g., intercept) data blocks of the requested content object received from the content source in response to the content request. The dictionary services provider can also calculate fingerprints as a function of byte-level information of the received data blocks of the requested content object. For example, the fingerprints can be generated by the dictionary server or generated by another component (e.g., the provider-side system) and communicated to the dictionary server. At stage 512′, the dictionary services provider can determine which data blocks of the content object are presently stored in a client-side dictionary of the subscriber terminal according to the fingerprints and the requested client dictionary model.

At stage 516′, the dictionary services provider can communicate to the transmission services provider which data blocks are determined to be presently stored in the client-side dictionary of the subscriber terminal. For example, the decision block of stage 612 represents a determination, for each data block, of whether that data block is presently stored in the requesting subscriber's dictionary according to the corresponding subscriber dictionary model and the generated fingerprints. If the block is determined not to be presently stored in the requesting subscriber's dictionary, the dictionary services provider can communicate the data block to the transmission services provider at stage 616. If the block is determined to be presently stored in the requesting subscriber's dictionary, the dictionary services provider can communicate an indication to that effect (e.g., a compressed version of the data block) to the transmission services provider at stage 620. For example, the fingerprint of the data block can be considered as a compressed version of the data. block in implementations where the subscriber terminal can use the fingerprint to retrieve and/or reconstruct (e.g., decrypt, decompress, etc.) a presently locally stored version of the data block.

At stage 624, the data blocks and fingerprints (or other compressed versions of the blocks) can be communicated to the requesting subscriber terminal. For example, the full data blocks can be multicast to the subscriber terminal and any number of other subscriber terminals (e.g., for anticipatory pre-positioning of the content in those subscriber terminals that elect to anticipatorily store the data blocks); while the compressed versions of the blocks can be unicast to the requesting subscriber terminal. In other implementations, the uncompressed and compressed data blocks can be communicated by the transmission services provider in any suitable manner. At stage 628, the requesting subscriber terminal can receive the uncompressed and compressed data blocks, and can use that received information to construct the requested content. For example, the requested content can be constructed using any previously stored data blocks that match fingerprints and using other received content blocks for any portions of the content that were not previously stored, that have changed since being previously stored, etc.

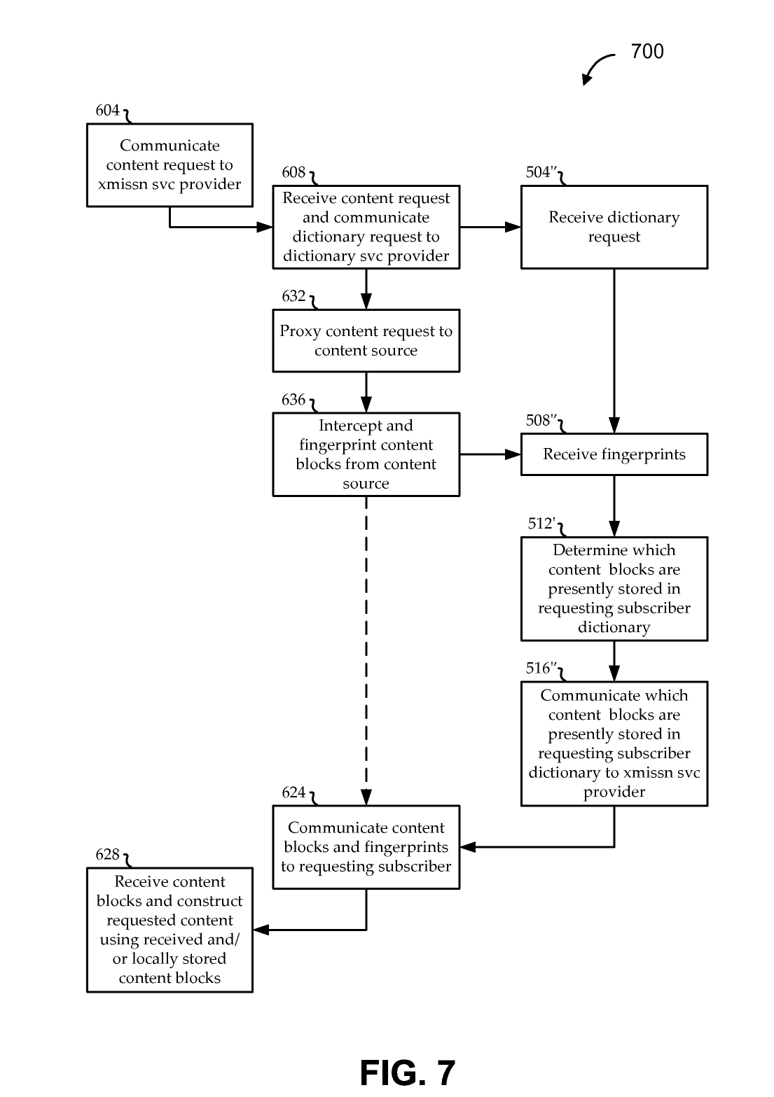

FIG. 7 shows a flow diagram of another method 700 for providing decoupled dictionary services, in which a transmission services provider performs proxy and fingerprinting functions, according to various embodiments. Embodiments of the method 700 begin, as in FIG. 6, by communicating a request from a subscriber terminal to a transmission services provider at stage 604, and by the transmission services provider receiving the content request and communicating a corresponding dictionary request to a dictionary services provider at stage 608. At stage 504″, embodiments of the method 700 continue by receiving the dictionary request by the dictionary services provider. As illustrated, the transmission services provider can communicate the content request to an appropriate content source on behalf of the requesting subscriber terminal (e.g., as a proxy) at stage 632. At stage 636, the transmission services provider can receive (e.g., intercept) data blocks of the requested content object received from the content source in response to the content request and can calculate fingerprints as a function of byte-level information of the received data blocks of the requested content object. At stage 508″, the dictionary services provider can receive the fingerprints from the transmission services provider.

As described with reference to FIG, 6, the dictionary services provider can determine which data blocks of the content object are presently stored in a client-side dictionary of the subscriber terminal according to the fingerprints and the requested client dictionary model at stage 512′. At stage 516″, the dictionary services provider can communicate to the transmission services provider which data blocks are determined to be presently stored in the client-side dictionary of the subscriber terminal according to the received fingerprints in any suitable manner. Since the transmission services provider can already have the data blocks and the fingerprints, there may be no reason to communicate either back to the transmission services provider. Rather, some implementations can communicate a list or other indication of which data blocks are and/or are not presently stored in the requesting subscriber's dictionary. Embodiments of the method 700 can proceed in the same way as described above with reference to FIG. 6. For example, the uncompressed and compressed data blocks can be communicated to the requesting subscriber terminal at stage 624, and the requesting subscriber terminal can receive and use the uncompressed and compressed data blocks to construct the requested content at stage 628.

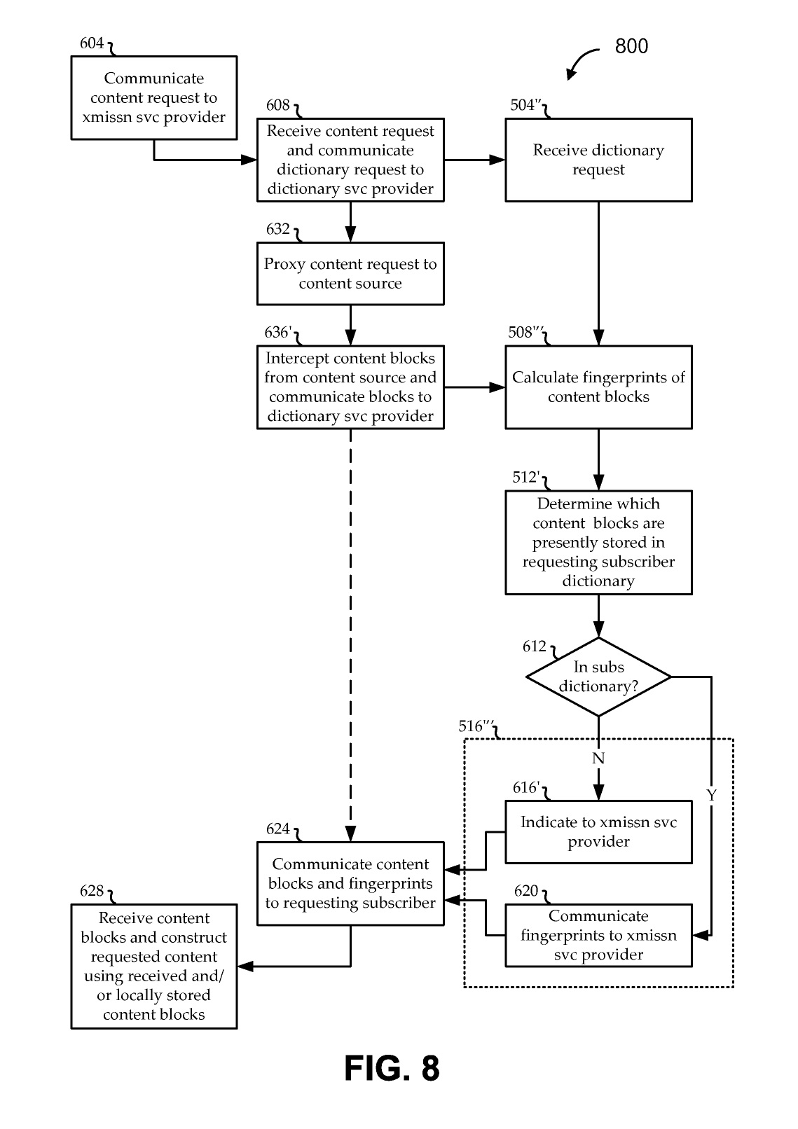

FIG. 8 shows a flow diagram of yet another method 800 for providing decoupled dictionary services, in which a transmission services provider and a dictionary services provider share performance of proxy and fingerprinting functions, according to various embodiments. Embodiments of the method 800 begin, as in FIGS. 6 and 7, by communicating a request from a subscriber terminal to a transmission services provider at stage 604, and by the transmission services provider receiving the content request and communicating a corresponding dictionary request to a dictionary services provider at stage 608. As in FIG. 7, embodiments of the method 800 can continue at stage 504″ by receiving the dictionary request by the dictionary services provider, and the transmission services provider can communicate the content request to an appropriate content source on behalf of the requesting subscriber terminal (e.g., as a proxy) at stage 632. At stage 636′, the transmission services provider can receive (e.g., intercept) data blocks of the requested content object received from the content source in response to the content request and can communicate the received data blocks to the dictionary services provider. At stage 508′″, the dictionary services provider can calculate fingerprints as a function of byte-level information of the received data. blocks of the requested content object.

As described with reference to FIGS. 6 and 7, the dictionary services provider can determine which data blocks of the content object are presently stored in a client-side dictionary of the subscriber terminal according to the fingerprints and the requested client dictionary model at stage 512′. At stage 516″′ the dictionary services provider can communicate to the transmission services provider which data blocks are determined to be presently stored in the client-side dictionary of the subscriber terminal. For example, the decision block of stage 612 represents a determination, for each data block, of whether that data block is presently stored in the requesting subscriber's dictionary according to the corresponding subscriber dictionary model and the generated fingerprints. If the block is determined not to be presently stored in the requesting subscriber's dictionary, implementations can communicate an indication to that effect to the transmission services provider at stage 616′ without communicating the actual data block (e.g., the transmission services provider can already have the data blocks it received in stage 636′). If the block is determined to be presently stored in the requesting subscriber's dictionary, the dictionary services provider can communicate an indication to that effect (e.g., a compressed version of the data block) to the transmission services provider at stage 620, as described above with reference to FIG. 6. Embodiments of the method 800 can again proceed in the same way as described above with reference to FIGS. 6 and 7. For example, the uncompressed and compressed data blocks can be communicated to the requesting subscriber terminal at stage 624, and the requesting subscriber terminal can receive and use the uncompressed and compressed data blocks to construct the requested content at stage 628.

Any of the above or other decoupled dictionary services implementations can be used to provide various features. In one illustrative scenario, the requested content is streaming media. At some previous time, portions of the streaming media were communicated to the subscriber terminal (e.g., anticipatorily, in response to a previous request, etc.). When the subscriber terminal issues the request for the media., the decoupled dictionary services techniques can be used to effectively fill in the gaps and communicate only the remaining portions of the streaming media not previously communicated, to repair corrupted or otherwise unusable data blocks that are presently locally stored, to replace any stale (or otherwise changed or incorrect) data blocks with latest versions of those data blocks, to provide additional information usable by the subscriber terminal for decoding (e.g., decompressing or decrypting) data blocks, etc. For example, these dictionary services techniques can provide the user with an apparent streaming experience, while potentially appreciably reducing real-time network resource usage. Moreover, this can allow the streaming media provider to implement rights management functions (e.g., encryption, time stamping, session management, etc.), and/or monetization functions (e.g., advertisement serving, etc.). By providing the dictionary services in a decoupled manner, embodiments can continue to provide these and/or other features even when the transmission services provider is potentially decoupled from the dictionary services provider. For example, the decoupled dictionary services techniques can facilitate provision of dictionary-related ser ices to nomadic subscribers via mobile subscriber terminals, and the like.

The methods disclosed herein include one or more actions for achieving the described method. The method and/or actions can be interchanged with one another without departing from the scope of the claims. In other words, unless a specific order of actions is specified, the order and/or use of specific actions can be modified without departing from the scope of the claims.

The various operations of methods and functions of certain system components described above can be performed by any suitable means capable of performing the corresponding functions. These means can be implemented, in whole or in part, in hardware, for example, as described above. Each can also be implemented, in whole or in part, with instructions embodied in a computer-readable medium, formatted to be executed by one or more general or application-specific controllers. The steps of a method or algorithm or other functionality described in connection with the present disclosure, can additionally or alternatively be embodied directly in hardware, in a software module executed by a processor, or in a combination of the two. For example, a software module can reside in any form of tangible storage medium, such as RAM, ROM, flash memory, EPROM memory, EEPROM memory, registers, hard disks, removable disks, etc. A storage medium can be coupled to one or more processors, such that the processors can read information from, and write information to, the storage medium. In the alternative, the storage medium can be integral to the processor. A software module can be a single instruction, or many instructions, and can be distributed over several different code segments, among different programs, and across multiple storage media. Thus, a computer program product can perform operations presented herein. For example, such a computer program product can be a computer readable tangible medium having instructions tangibly stored (and/or encoded) thereon, the instructions being executable by one or more processors to perform the operations described herein. The computer program product can include packaging material. Software or instructions can also be transmitted over a transmission medium. For example, software can be transmitted from a website, server, or other remote source using a transmission medium such as a coaxial cable, fiber optic cable, twisted pair, digital subscriber line (DSL), or wireless technology such as infrared, radio, or microwave.

Other examples and implementations are within the scope and spirit of the disclosure and appended claims. For example, features implementing functions can also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples.

Various changes, substitutions, and alterations to the techniques described herein can be made without departing from the technology of the teachings as defined by the appended claims. Moreover, the scope of the disclosure and claims is not limited to the particular aspects of the process, machine, manufacture, composition of matter, means, methods, and actions described above. Processes, machines, manufacture, compositions of matter, means, methods, or actions, presently existing or later to be developed, that perform substantially the same function or achieve substantially the same result as the corresponding aspects described herein can be utilized. Accordingly, the appended claims include within their scope such processes, machines, manufacture, compositions of matter, means, methods, or actions.

What is claimed is:

1. A method for communicating content to a plurality of subscriber terminals over a communications network, the method comprising:
receiving, by a dictionary server of a dictionary services provider from a provider-side system of a transmission services provider, a dictionary request for one of a plurality of client dictionary models associated with one of a plurality of subscriber terminals, the dictionary request corresponding to a content request by the subscriber terminal for receipt of a content object from a content source;
receiving, by the dictionary sever, fingerprints generated as a function of byte-level information of data blocks of the content object;
determining, by the dictionary server in response to receiving the dictionary request, which data blocks of the content object are presently stored in a client-side dictionary of the subscriber terminal according to the fingerprints and the requested client dictionary model; and
communicating, from the dictionary server to the provider-side system, which data blocks are determined to be presently stored in the client-side dictionary of the subscriber terminal.

2. The method of claim 1, wherein communicating which data blocks are determined to be presently stored in the client-side dictionary of the subscriber terminal comprises:
instructing the provider-side system to communicate to the subscriber terminal only those data blocks of the content object indicated as not presently stored in the client-side dictionary.

3. The method of claim 2, wherein instructing the provider-side system to communicate only those data blocks of the content object indicated as not presently stored in the client-side dictionary comprises instructing the provider-side system to multicast at least some of those data blocks of the content object indicated as not presently stored in the client-side dictionary.

4. The method of claim 1, wherein communicating which data blocks are determined to be presently stored in the client-side dictionary of the subscriber terminal comprises:
communicating, from the dictionary server to the provider-side system, compressed versions of the data blocks determined to be presently stored in the client-side dictionary of the subscriber terminal; and
instructing the provider-side system to communicate the compressed versions of the data blocks to the subscriber terminal in lieu of communicating the data blocks determined to be presently stored in the client-side dictionary of the subscriber terminal.

5. The method of claim 1, wherein:
the provider-side system receives the data blocks of the content object and generates the fingerprints as a function of the byte-level information of the received data blocks; and
the dictionary server receives the generated fingerprints from the provider-side system.

6. The method of claim 1, wherein:
the dictionary server receives the data blocks of the content object in response to the content request;
a first component of the dictionary server generates the fingerprints as a function of the byte-level information of the data blocks; and
a second component of the dictionary server receives the generated fingerprints from the first component of the dictionary server.

7. The method of claim 6, further comprising:
communicating the content request to the content source by e dictionary server as a proxy for the requesting subscriber terminal.

8. The method of claim 1, wherein:
the provider-side system receives the data blocks of the content object and communicates the received data blocks to a first component of the dictionary server;
the first component of the dictionary server generates the fingerprints as a function of the byte-level information of the data blocks; and
a second component of the dictionary server receives the generated fingerprints from the first component of the dictionary server.

9. The method of claim 1, wherein the subscriber terminal is a mobile subscriber terminal.

10. The method of claim 1, wherein the dictionary request is received only when the subscriber is determined to be a subscriber to dictionary services.

11. The method of claim 1, wherein the content request is an explicit request for the content object from the subscriber terminal.

12. The method of claim 1, wherein the content request is an implicit request for the content object from the subscriber terminal.

13. A dictionary services provider system for communicating content to a plurality of subscriber terminals over a communications network, the system comprising:
a storage comprising a plurality of client dictionary models associated with subscriber dictionaries of a plurality of subscriber terminals; and
a dictionary server, in communication with the storage, that operates to:
receive a dictionary request from a provider-side system of a transmission services provider, the dictionary request corresponding to a content request by one of the subscriber terminals for receipt of a content object from a content source;
receive fingerprints generated as a function of byte-level information of data blocks of the requested content object;
determine which data blocks of the content object are presently stored in a client-side dictionary of the subscriber terminal according to the fingerprints and according to one of the client dictionary models that corresponds to the requesting subscriber terminal; and
communicate, to the provider-side system, which data blocks are determined to be presently stored in the client-side dictionary of the subscriber terminal.

14. The system of claim 13, wherein the dictionary server operates to communicate which data blocks are determined to be presently stored in the client-side dictionary of the subscriber terminal by instructing the provider-side system to communicate to the subscriber terminal only those data blocks of the content object indicated as not presently stored in the client-side dictionary.

15. The system of claim 13, wherein the dictionary server operates to communicate which data blocks are determined to be presently stored in the client-side dictionary of the subscriber terminal by:
communicating, to the provider-side system, compressed versions of the data blocks determined to be presently stored in the client-side dictionary of the subscriber terminal; and
instructing the provider-side system to communicate the compressed versions of the data blocks to the subscriber terminal in lieu of communicating the data blocks determined to be presently stored in the client-side dictionary of the subscriber terminal.

16. The system of claim 13, wherein:
the provider-side system receives the data blocks of the content object and generates the fingerprints a function of the byte-level information of the data blocks; and
the dictionary server operates to receive the fingerprints by receiving the generated fingerprints from the provider-side system.

17. The system of claim 13, wherein:
the dictionary server further operates to receive the data blocks of the content object in response to the content request; and
the dictionary server operates to receive the fingerprints by:
generating, by a first component of the dictionary server, the fingerprints as a function of the byte-level information of the data blocks; and
receiving, by a second component of the dictionary server, the generated fingerprints from the first component of the dictionary server.

18. The system of claim 13, wherein:
the provider-side system receives the data blocks of the content object and communicates the received data blocks to a first component of the dictionary server; and
the dictionary server operates to receive the fingerprints by:
generating, by a first component of the dictionary server, the fingerprints as a function of the byte-level information of the data blocks; and
receiving, by a second component of the dictionary server, the generated fingerprints from the first component of the dictionary server.

19. The system of claim 13, wherein the dictionary server is in communication with a plurality of provider-side systems, each associated with a respective transmission services provider.

20. A dictionary services provider system for communicating content to a plurality of subscriber terminals over a communications network, the system comprising:
a set of processors; and
a non-transient computer-readable storage medium, in communication with the set of processors and with a plurality of client dictionary models associated with subscriber dictionaries of a plurality of subscriber terminals, the storage medium having instructions stored thereon which, when executed, cause the set of processors to:
receive a dictionary request from a provider-side system of a transmission services provider, the dictionary request corresponding to a. content request by one of the subscriber terminals for receipt of a content object from a content source;
receive fingerprints generated as a function of byte-level information of data blocks of the requested content object;
determine which data blocks of the content object are presently stored in a client-side dictionary of the subscriber terminal according to the fingerprints and according to one of the client dictionary models that corresponds to the requesting subscriber terminal; and
communicate, to the provider-side system, which data blocks are determined to be presently stored in the client-side dictionary of the subscriber terminal.
